(19) United States
(12) Patent Application Publication
(10) Pub. No.: US 2013/0325758 A1
(43) Pub. Date: Dec. 5, 2013

(54) TAILORED OPERATING SYSTEM LEARNING EXPERIENCE

(71) Applicants: Thomas Henry Alphin, III, Kirkland, WA (US); Maverick J. Velasco, Sammamish, WA (US); Christopher J. McGuire, Monroe, WA (US)

(72) Inventors: Thomas Henry Alphin, III, Kirkland, WA (US); Maverick J. Velasco, Sammamish, WA (US); Christopher J. McGuire, Monroe, WA (US)

(73) Assignee: MICROSOFT CORPORATION, Redmond, WA (US)

(21) Appl. No.: 13/563,351

(22) Filed: Jul. 31, 2012

Related U.S. Application Data
(60) Provisional application No. 61/653,261, filed on May 30, 2012.

(51) Int. Cl. G06F 15/18

(52) U.S. Cl. 706/12

(57) ABSTRACT

This document describes techniques and apparatuses enabling a tailored operating system learning experience. The techniques can tailor a learning experience to a user's computing device or a user's specifications. This tailoring to the user's computing device may include an interactive demonstration showing a new feature controlled through a mouse if the user's computing device has a mouse, or a touchscreen if the user's computing device has a touchscreen, for example. Further, this tailoring may include showing a new feature according to a user's specifications, such as describing a feature using a large font or with a large, bright mouse-pointer if the user indicated that he or she is visually impaired.

### RELATED APPLICATIONS

This application claims priority to U.S. Provisional Application Ser. No. 61/653,261, filed May 30, 2012, entitled “TAILORED OPERATING SYSTEM LEARNING EXPERIENCE”, to Thomas Henry Alphin, III, et al., the disclosure of which is hereby incorporated by reference herein in its entirety.

### BACKGROUND

Software developers continue to create new applications and improve existing applications. Operating systems, for example, continue to improve, with new functions and abilities being added regularly. Many of these applications and improvements, however, must first be taught to users before they can be properly enjoyed.

Conventionally, software developers train users through audio-visual tutorials. These tutorials typically involve a person explaining a feature while showing a computer performing the feature. These tutorials are generally scripted and linear, offering users little or no ability to interact with the feature. They also tend to explain a feature in the context of a single computing device having a single configuration, such as a person showing a feature on a laptop computer having a touchpad, but not on other computing devices that may also have the feature, like a smart phone with a keyboard, a tablet with a touchscreen, or a desktop computer with a mouse. Further still, these tutorials often do not demonstrate features as the features will appear to the user, or be used by the user, when the application is executing on the user's computer. A person that speaks Norwegian, for example, may only have a tutorial available in English. A visually-impaired user, for example, may only have a tutorial showing small fonts that are unreadable by the user.

### SUMMARY

This document describes techniques and apparatuses enabling a tailored operating system learning experience. The techniques can tailor a learning experience to a user's computing device or a user's specifications. This tailoring to the user's computing device may include an interactive demonstration showing a new feature controlled through a mouse if the user's computing device has a mouse, or a touchscreen if the user's computing device has a touchscreen, for example. Further, this tailoring may include showing a new feature according to a user's specifications, such as describing a feature using a large font or with a large, bright mouse-pointer if the user indicated that he or she is visually impaired.

This summary is provided to introduce simplified concepts that are further described below in the Detailed Description. This summary is not intended to identify essential features of the claimed subject matter, nor is it intended for use in determining the scope of the claimed subject matter. Techniques and/or apparatuses enabling a tailored operating system learning experience are also referred to herein separately or in conjunction as the “techniques” as permitted by the context.

### BRIEF DESCRIPTION OF THE DRAWINGS

Embodiments enabling a tailored operating system learning experience are described with reference to the following drawings. The same numbers are used throughout the drawings to reference like features and components:

FIG. 1 illustrates an example system in which techniques enabling a tailored operating system learning experience can be implemented.

FIG. 2 illustrates example methods for tailoring an operating system (OS) learning experience where the learning experience explains a gesture feature of the operating system.

FIG. 3 illustrates an example of a tailored portion of a tailored OS learning experience in an immersive environment of a tablet computer of FIG. 1.

FIG. 4 illustrates an example of a default portion of an OS learning experience directed to a same gesture feature as FIG. 3.

FIG. 5 illustrates example methods for creating an OS learning experience using learning-experience subsets.

FIG. 6 illustrates example sets of learning-experience subsets.

FIG. 7 illustrates retrieved learning-experience subsets of FIG. 6 and customized, retrieved learning-experience subsets.

FIG. 8 illustrates example methods for creating an OS learning experience including responsive to an initial login event.

FIG. 9 illustrates examples of an actual side-bar menu and an abstracted side-bar menu.

FIG. 10 illustrates an example device in which techniques enabling a tailored operating system learning experience can be implemented.

### DETAILED DESCRIPTION

### Overview

This document describes techniques and apparatuses enabling a tailored operating system (OS) learning experience. Consider, for example, a case where a user buys a new laptop having a new operating system. Assume that this laptop has a touchscreen display and a keyboard but no mouse, touchpad, or the like. On booting up the laptop, the techniques may enable the user to select specifications to customize the operating system environment. Assume that the user selects a language (Australian English), a color scheme, a font (Times New Roman), a font size (14, slightly larger than average), and to have the OS pointer a dark red rather than a default gray color.

Based on the laptop's hardware characteristics and the user specifications, the techniques create a tailored OS learning experience. The techniques may do so without further user interaction, and may do so quickly, thereby enabling the user to move rapidly from booting the laptop and selecting specifications to the learning experience. The tailored OS learning experience then begins, explaining, demonstrating, and enabling interaction with various new features and abilities of the new operating system and tailored to the user's device and customizations. When the user reads text from the learning experience, it is in Times New Roman font at size 14. When the user views a pointer it is dark red. When the learning experience explains something in audio, it is in Australian English. And when the learning experience demonstrates features, such as a new gesture, the learning experience demonstrates the gesture selected through a touchscreen but not through a mouse or touchpad because the user's laptop does not include a mouse or touchpad.

These are but a few examples of many ways in which the techniques enable a tailored OS learning experience, others of which are described below.

### Example System

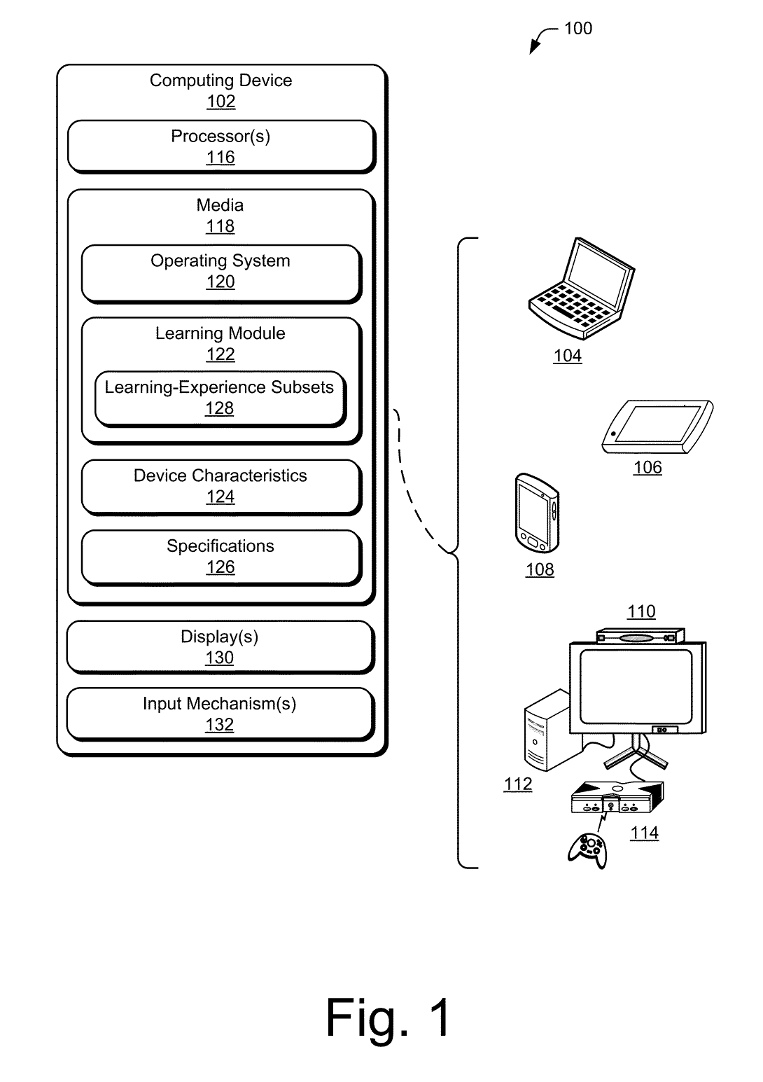

FIG. 1 illustrates an example system 100 in which techniques enabling a tailored operating system learning experience can be embodied. System 100 includes a computing device 102, which is illustrated with six examples: a laptop computer 104, a tablet computing device 106, a smart phone 108, a set-top box 110, a desktop computer 112, and a gaming device 114, though other computing devices and systems, such as servers and netbooks, may also be used.

Computing device 102 includes computer processor(s) 116 and computer-readable storage media 118 (media 118). Media 118 includes an operating system 120, learning module 122, device characteristics 124, and specifications 126.

Operating system 120 is one of various applications for which the techniques may tailor a learning experience. Operating system 120 may enable a windows-based or immersive environment or both. Windows-based environments present application user interfaces through windows having frames. These frames may provide controls through which to interact with an application and/or controls enabling a user to move and resize the window. Immersive environments, in some embodiments, presents content of, and enable interaction with, applications with little or no window frame, without a need for a user to manage a window frame's layout or primacy relative to other windows (e.g., which window is active or up front), without a need for a user to manually size or position application user interfaces, and/or without presenting visual controls (e.g., permanent controls on a window frame or in a window obscuring content).

Learning module 122 is capable of creating and/or tailoring a learning experience for an application to a computing device's characteristics and/or specifications. Learning module 122 may create a tailored learning experience for a newly installed application thereby enabling a user to properly use and enjoy the newly installed application. In the context of tailoring a learning experience to operating system 120, learning module 122 may first enable a user to select specifications on an initial login event, after which learning module 122 creates the tailored learning experience and presents it to a user, though this is not required.

Learning module 122, in some embodiments, builds a learning experience from learning-experience subsets 128. Each of these subsets 128 is a portion of software and/or other media capable of explaining a feature of operating system 120 for a particular kind of device characteristic 124. For a particular gesture feature, such as an edge gesture, corner gesture, or sizing gesture, for example, assume that eight possible characteristics affect use (and thus a learning experience of) the gesture: a stationary external mouse, such as one having a large track ball; a mobile external mouse; an eraser-top keyboard mouse; a touchpad; a small touch screen for smartphones and small tablets; a large touch screen for large tablets, laptops, and desktops; a rollerball (for handheld devices); and a motion-sensing camera. In this example case, learning-experience subsets 128 include eight different subsets, one for each of these characteristics 124. If a user's computing device is a handheld computer (e.g., smartphone 108), for example, that has a touchscreen and a rollerball, these two learning-experience subsets 128 may be used in creating a tailored learning experience for that gesture but not the other six learning-experience subsets 128.

Device characteristics 124 are characteristics of a device that may affect a learning experience. Non-limiting examples include display size or type, input mechanisms, audio capabilities, and other hardware or software, such as graphics cards used, wireless capabilities, and so forth.

Specifications 126 are settings, preferences, and/or customizations that may affect a learning experience, whether user-selected or by default. Non-limiting examples include color, language, fonts, font sizes, font effects (shadowing, etc.), language, display orientation (e.g., landscape or upright), cultural specifications (e.g., top-to-bottom, left-to-right, right-to-left, bottom-to-top gesture or text orientations of Arabic, English, Japanese, and Chinese), and disability settings (e.g., for sight, hearing, or mobility impaired).

Computing device 102 also includes or has access to one or more displays 130 and input mechanisms 132. Four example displays are illustrated in FIG. 1. Input mechanisms 132 may include those noted above as well as many others, such as biometric and passive environmental sensors. These sensors include, for example, the above-mentioned movement-tracking camera, heat sensors capable of measuring a person's movement, orientation, or distance, and sensors measuring a person's respiration or heart rate, just to name a few. Still other sensors may provide information sufficient to determine a person's location, culture (whether location dependent or independent), geopolitical data, and language. Input mechanism 132 may also include other gesture-sensitive sensors and devices, such as touch-based sensors and mice (free-standing or integral with a keyboard), track and touch pads, and microphones with accompanying voice recognition software, to name a few. Input mechanisms 132 may be separate or integral with displays 130; integral examples include gesture-sensitive displays with integrated touch-sensitive or motion-sensitive sensors.

### Example Methods

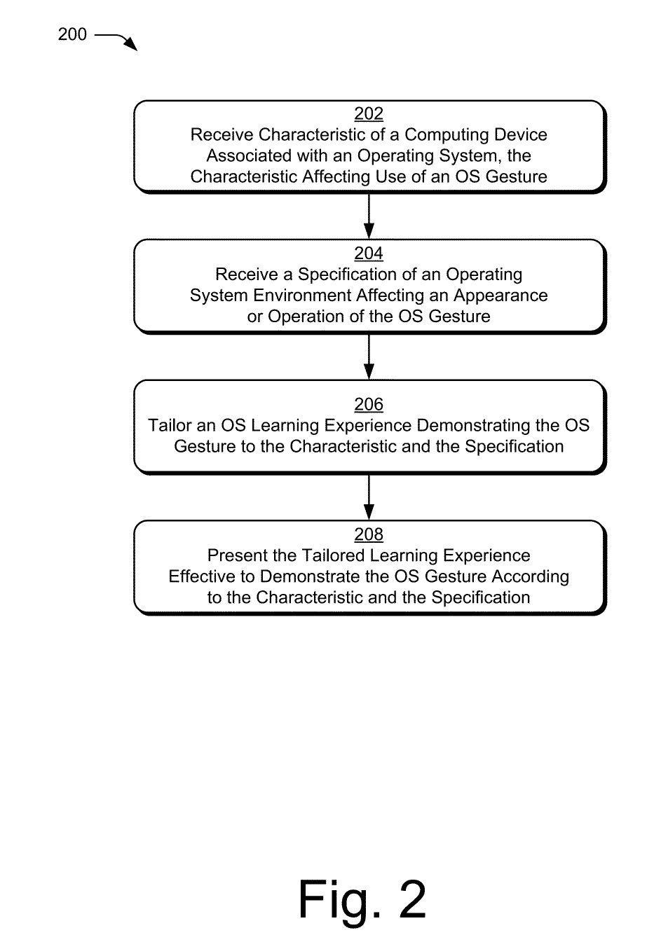

FIG. 2 depicts methods 200 for tailoring an operating system (OS) learning experience where the learning experience explains a gesture feature of the operating system. In portions of the following discussion, reference may be made to example system 100 of FIG. 1 and other methods and example embodiments described elsewhere herein, reference to which is made for example only.

Block 202 receives a characteristic of a computing device, the computing device associated with an operating system (OS), the characteristic affecting use of an OS gesture. As noted in part above, the characteristic of the computing device can be a hardware characteristic, such as input mechanism 132 of FIG. 1 (e.g., a touch-sensitive display or a physical keyboard), though software or combined hardware and software characteristics may also be received. For methods 200, the characteristic is one that affects use of an OS gesture, though this is not generally required by the techniques.

Block 204 receives a specification of an OS environment affecting an appearance or operation of the OS gesture. As noted above, specifications may affect how a feature operates or appears. The appearance can be affected by, for example, a color, font type, font size, or pointer type or size. An operation of a gesture can be affected by various OS environment specifications, such as a left-to-right or right-to-left orientation, which can vary among cultures and languages.

Block 206 tailors an OS learning experience explaining the OS gesture to the characteristic and the specification. By way of example, assume that the characteristic indicates that the computing device supports gesture input only though a touchscreen display, here for tablet computer 106 of FIG. 1, and that the touchscreen display is larger rather than small, in contrast to smartphone 108 of FIG. 1. Assume also that two specifications affecting the OS gesture are received, one affecting the appearance and another affecting an operation of the gesture, namely selection of visual impairment and Arabic, respectively.

In this example embodiment, learning module 122 receives this characteristic and two specifications and, once received, tailors an OS learning experience to the characteristic and specifications. For this example the discussion focuses on a particular gesture being explained, here an edge gesture enabling a quick flick-like gesture to deselect presentation of a currently displayed application interface in an immersive environment and to select another application interface for another application. This example considers use of this gesture in the context of selecting applications arranged in a carousel orientation, though this is for example only.

Block 208 presents the tailored OS learning experience effective to demonstrate the use of the OS gesture according to the characteristic of the computing device and with the appearance or operation of the specification.

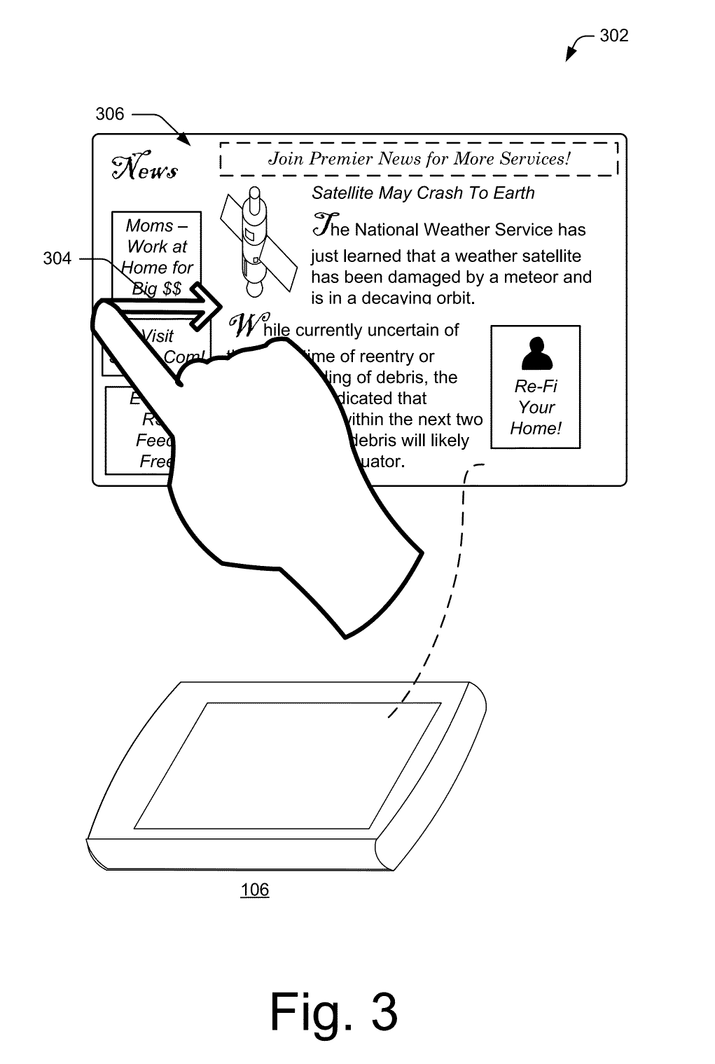

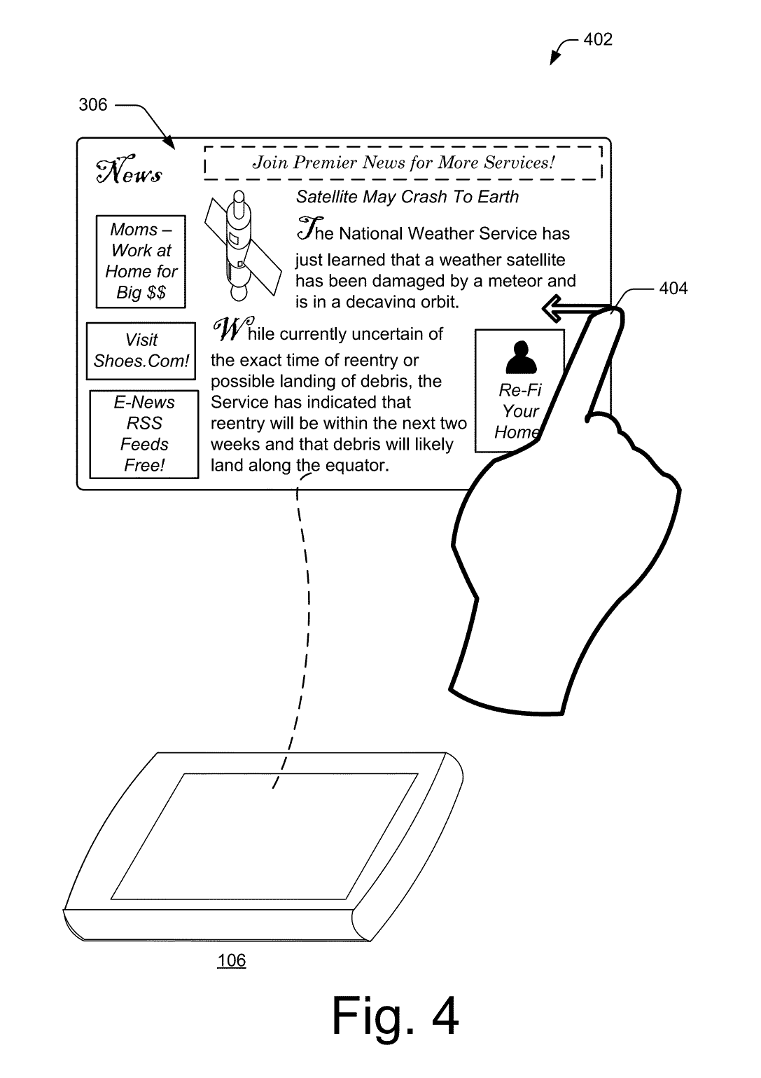

Concluding the ongoing example, consider FIG. 3, which illustrates a tailored portion 302 of a tailored OS learning experience having a large gesture indicator 304 and currently presenting a current application interface 306 in an immersive environment of tablet computer 106 of FIG. 1. Learning module 122 tailored this tailored portion 302 to the device having a touchscreen, with the size of the gesture indicator, and with the operation of the gesture being from left-to-right. Contrast this tailored OS learning experience with FIG. 4, which illustrates a default portion 402 of an OS learning experience directed to the same gesture feature, but with a default gesture indicator 404 and having a right-to-left orientation.

Thus, learning module 122 tailors the OS learning experience in this example effective to demonstrate the OS gesture entered through the touch-sensitive display as affected by the characteristic. Learning module 122 also tailors the OS learning experience in this example to both an appearance and operation affected by the specifications, namely the size of gesture indicator and orientation of the gesture's operation being left-to-right.

The tailored OS learning experience may enable various interactions by a user using the experience, including in real time, such as to attempt the edge gesture during the presentation of the tailored OS learning experience. Learning module 122 may work in conjunction with OS 120 to enable these interactions. Thus, on the attempt to make an edge gesture, for example, learning module 122 may provide or pass the touch input made through tablet computer 106's touchscreen to OS 120, OS 120 may determine if the gesture is a proper gesture based on the initial touch point, the size of the edge based on the size of the display or other factors (e.g., sensitively of input mechanism), whether the initial touch point is within the edge, and an angle from the edge being sufficiently perpendicular to the edge, and so forth. OS 120 may then pass this determination back to learning module 122. In response, learning module 122 may interactively tailor the learning experience to train the user on the edge gesture if the touch input was improper for edge gestures.

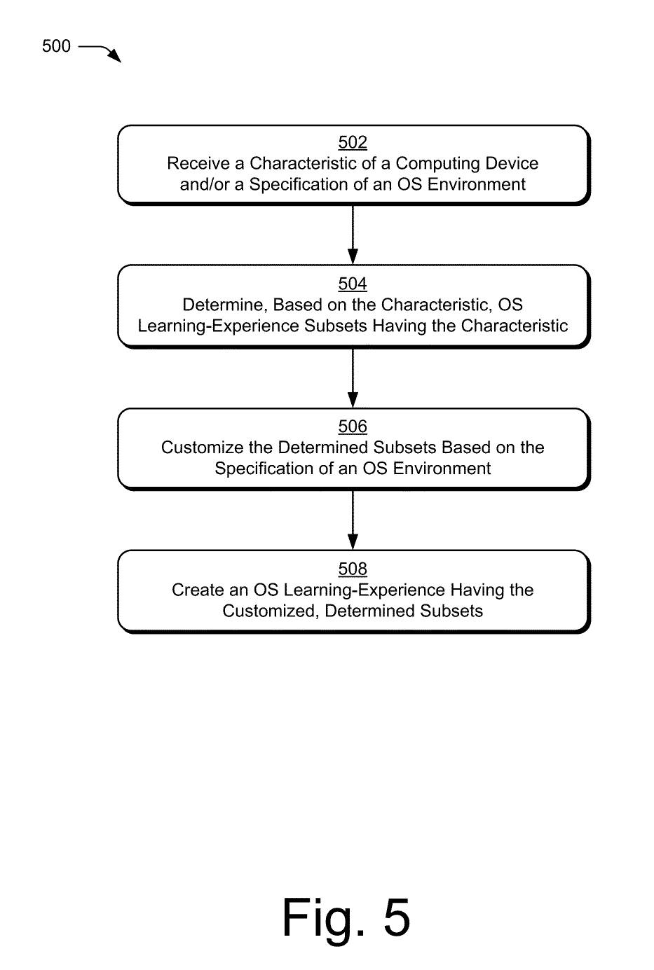

FIG. 5 depicts methods 500 for creating an OS learning experience using learning-experience subsets. In portions of the following discussion reference may be made to system 100 of FIG. 1, reference to which is made for example only. Methods 500 may act in conjunction with other methods described herein, whether in whole or in part.

Block 502 receives a characteristic of a computing device and/or a specification of an OS environment. Block 502 may act similarly to blocks 202 and 204 of methods 200, though similarly is not required.

Block 504 determines, based on the characteristic of the computing device and from a set of operating system (OS) learning-experience subsets each associated with a feature and a potential characteristic, the subsets of the set associated with the characteristic.

Consider again the learning-experience subsets 128 of FIG. 1. As noted, each of subsets 128 may be directed to a particular feature of an application to be taught by the learning experience and a characteristic. Thus, if two characteristics may affect a feature, two subsets 128 may be part of the set from which learning module 122 may select one or both of subsets 128.

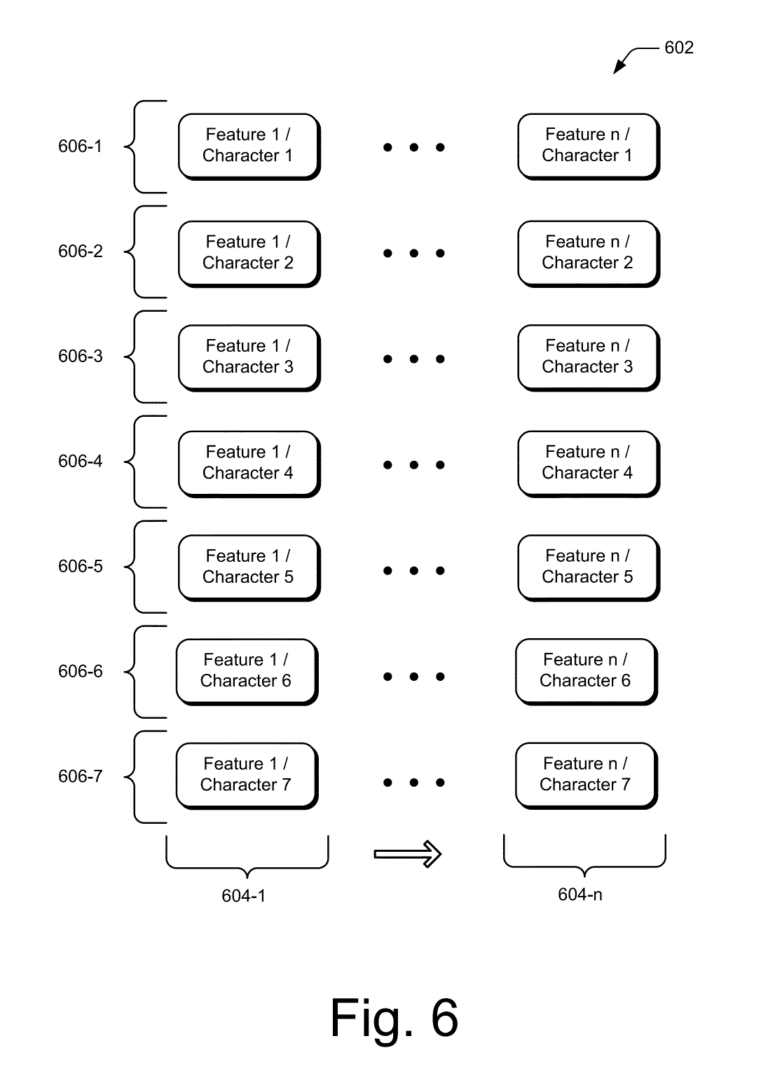

In more detail, consider FIG. 6, which illustrates sets 602 directed to a number of features 604, where the number of features is from 1 to a maximum number N of features associated with an application or OS. Each of features 604 can be affected by characteristics 606, though some features may be independent of characteristics of a computing device.

Characteristics 606 may include up to an arbitrary number of characteristics of a device capable of affecting features (e.g., from 1 to X). For visual brevity, however, seven characteristics capable of affecting features generally are illustrated: small display with mouse 606-1; small display with touchscreen 606-2; small display with eyeball-tracking sensors 606-3; large display with mouse 606-4; large display with keyboard 606-5; large display with touchscreen 606-6; and large display with heat-sensing camera 606-7. As noted, feature 604-1 is directed to sizing application interfaces in an immersive environment.

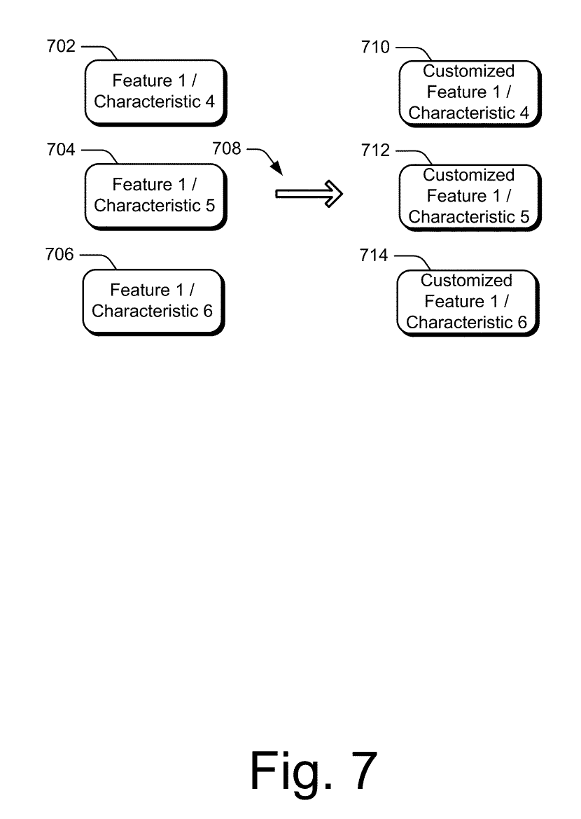

Assume, for example, that learning module 122 receives, at block 502, three characteristics, here of desktop computer 112 of FIG. 1, namely large display with mouse 606-4, large display with keyboard 606-5, and large display with touchscreen 606-6. Based on these characteristics, learning module 122 retrieves three subsets from subsets 602 of FIG. 6. These retrieved subsets are illustrated in FIG. 7 with a first subset 702, a second subset 704, and a third subset 706. First subset 702 includes software and/or media enabling demonstration of an immersive environment feature on a large display and using a mouse. Second subset 704 includes software and/or media enabling demonstration of an immersive environment feature on a large display and using a keyboard, such as with hotkeys, key combinations, and the like. Third subset 706 includes software and/or media enabling demonstration of an immersive environment feature on a large display and using a touchscreen.

Returning to methods 500, block 506 customizes the determined subsets based on a specification of an OS environment. Continuing the ongoing embodiment, assume that, at block 502, learning module 122 receives a color specification for the OS environment. In such a case, learning module 122 may customize the subsets, namely first subset 702, second subset 704, and third subset 706 of FIG. 7. Alternatively, learning module 122 may mark or minimally alter determined subsets for some specification, these marks or alterations sufficient to cause the determined subsets to be presented according to the specification in conjunction with the application or OS for which the learning experience is tailored, such with OS 120 interacting with the learning experience to alter the color scheme. In the ongoing example, however, learning module 122 customizes the determined subsets to have the color specification. This is represented in FIG. 7 with alter appearance action 708 and results in appearance-altered subset 710, appearance-altered subset 712, and appearance-altered subset 714.

Block 508 creates an OS learning experience having the customized, determined subsets, the OS learning experience enabling demonstration of the features according to the characteristic and the specification. Block 508 may be repeated to build a learning experience for multiple features, and thus create a learning experience covering many features that are specific to a device's characteristics and various specifications.

Concluding the ongoing example, learning module 122 creates an OS learning experience tailored to three characteristics of desktop computer 112 of FIG. 1 and having a user's color scheme. Note that each feature may have different functions and operations based on a characteristic, and in some cases specifications (e.g., operational specifications). In the above immersive environment sizing feature, for example, a small touch display may permit sizing with a squeeze or spread two-finger gesture and thus learning module 122 builds a learning experience teaching these gestures and on a small touch display. This same immersive environment sizing feature for a large display with a heat-sensing camera, however, may permit sizing with a hand wave, arm circular motion, or single hand clap. Thus, a broad range of customizations are permitted by the techniques.

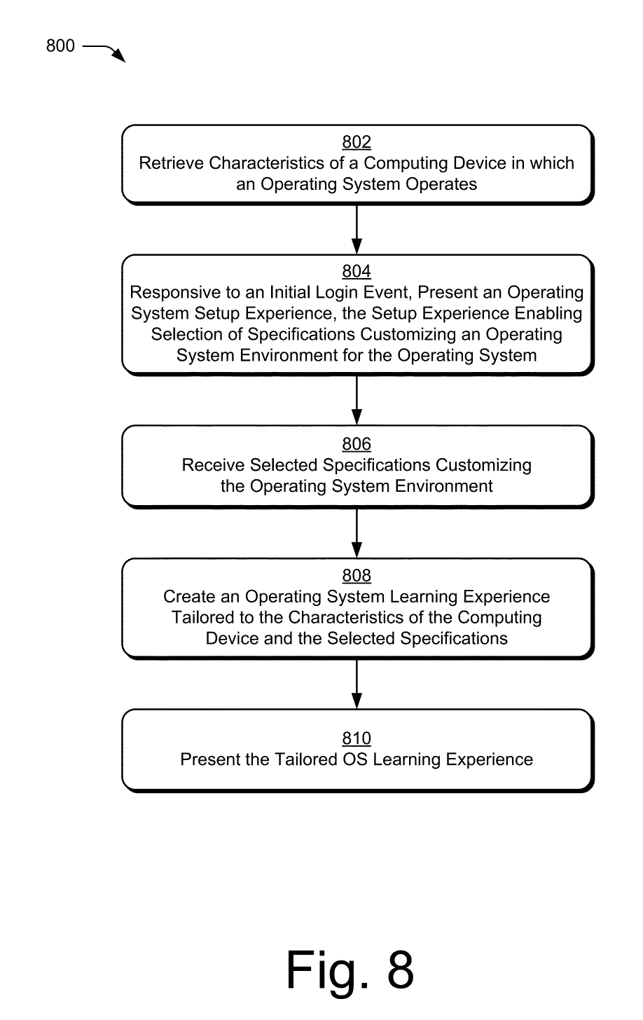

FIG. 8 depicts methods 800 for creating an OS learning experience, including responsive to an initial login event. In portions of the following discussion reference may be made to system 100 of FIG. 1, reference to which is made for example only. Methods 800 may act in conjunction with other methods described herein, whether in whole or in part.

Block 802 retrieves characteristics of a computing device with which an operating system (OS) is associated, this may be performed in any of the various manners set forth or contemplated above. These characteristics may be retrieved, in cases of a first boot or login, without aid from software operating after a full boot, in some cases.

Block 804, responsive to an initial login event, presents an OS setup experience, the setup experience enabling selection of specifications to customize an OS environment for the OS. The OS setup experience may be part of or separate from the learning experience. By way of example, consider a case where learning module 122 builds a setup experience tailored to the characteristics of the computing device, such as the device's keyboard or screen size. Examples of tailoring based on characteristics are set forth above, and may be followed by methods 800 in building a setup experience based on characteristics.

Block 804 acts responsive to the initial login event, which may be a first boot of the OS or an entity's first login to the computing device, as well as others.

Block 806 receives selected specifications customizing the OS environment. As noted, selection is enabled by, and received through, the setup experience. Note that some specifications can be received from other sources as noted above.

Block 808 creates an OS learning experience tailored to the characteristics of the computing device and the selected specifications.

Block 810 presents the tailored OS learning experience. As noted in part above, this tailored OS learning experience may demonstrates use of a gesture usable to interact with or manage the OS, though this is not required. Further, while these methods are described in the context of an OS, the techniques may also tailored learning experiences to various applications, such as a word-processing application, web browser, and so forth.

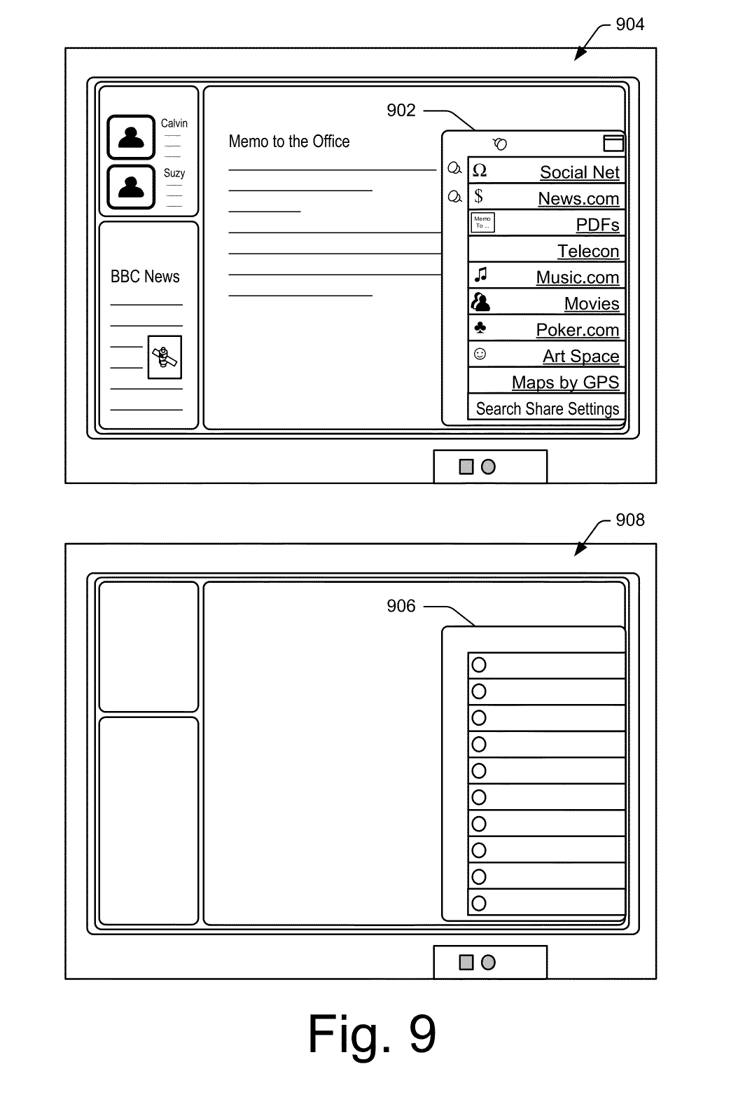

Note also that the tailored OS learning experience may include or be presented to demonstrate, and enable interaction with, features as they would appear according to a device, its characteristics, and specifications. Alternatively, however, abstractions may instead be used, such as those reducing a complexity of an actual representation. Consider one example of this where a side-bar menu feature is demonstrated. FIG. 9 illustrates an actual side-bar menu 902 along with an actual immersive environment 904. The alternative abstraction is shown with an abstracted side-bar menu 906 along with an abstracted immersive environment 908. In some cases it is useful to present abstractions when teaching a feature, such as when the actual complexity would visually or cognitively confuse or complicate the learning experience.

The preceding methods are shown as sets of blocks that specify operations performed but are not necessarily limited to the order shown for performing the operations by the respective blocks. Furthermore, these methods, in whole or in part, can be used in combination.

Aspects of these methods may be implemented in hardware (e.g., fixed logic circuitry), firmware, a System-on-Chip (SoC), software, manual processing, or any combination thereof. A software implementation represents program code that performs specified tasks when executed by a computer processor, such as applications, routines, programs, objects, components, data structures, procedures, modules, functions, and the like. The program code can be stored in one or more computer-readable memory devices, both local and/or remote to a computer processor. The methods may also be practiced in a distributed computing environment by multiple computing devices.

### Example Device

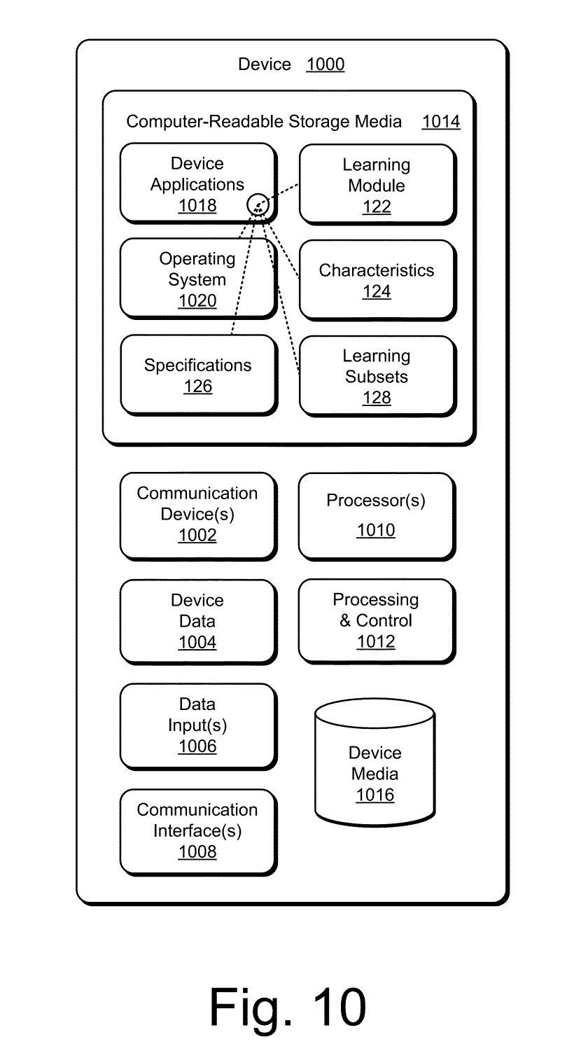

FIG. 10 illustrates various components of example device 1000 that can be implemented as any type of client, server, and/or computing device as described with reference to the previous FIGS. 1-9 to implement techniques and/or apparatuses for tailoring an OS learning experience. In embodiments, device 1000 can be implemented as one or a combination of a wired and/or wireless device, as a form of television client device (e.g., television set-top box, digital video recorder (DVR), etc.), consumer device, computer device, server device, portable computer device, user device, communication device, video processing and/or rendering device, appliance device, gaming device, electronic device, and/or as another type of device. Device 1000 may also be associated with a user (e.g., a person) and/or an entity that operates the device such that a device describes logical devices that include users, software, firmware, and/or a combination of devices.

Device 1000 includes communication devices 1002 that enable wired and/or wireless communication of device data 1004 (e.g., received data, data that is being received, data scheduled for broadcast, data packets of the data, etc.). The device data 1004 or other device content can include configuration settings of the device, media content stored on the device, and/or information associated with a user of the device. Media content stored on device 1000 can include any type of audio, video, and/or image data. Device 1000 includes one or more data inputs 1006 via which any type of data, media content, and/or inputs can be received, such as user-selectable inputs, messages, music, television media content, recorded video content, and any other type of audio, video, and/or image data received from any content and/or data source.

Device 1000 also includes communication interfaces 1008, which can be implemented as any one or more of a serial and/or parallel interface, a wireless interface, any type of network interface, a modem, and as any other connection and/or communication links between device 1000 and a communication network by which other electronic, computing, and communication devices communicate data with device 1000.

Device 1000 includes one or more processors 1010 (e.g., any of microprocessors, controllers, and the like), which process various computer-executable instructions to control the operation of device 1000 and to enable techniques enabling a tailored OS learning experience. Alternatively or in addition, device 1000 can be implemented with any one or combination of hardware, firmware, or fixed logic circuitry that is implemented in connection with processing and control circuits, which are generally identified at 1012. Although not shown, device 1000 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 1000 also includes computer-readable storage media 1014, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 1000 can also include a mass storage media device (device media) 1016.

Computer-readable storage media 1014 provides data storage mechanisms to store device data 1004, as well as various device applications 1018 and any other types of information and/or data related to operational aspects of device 1000. For example, an operating system 1020 can be maintained as a computer application with the computer-readable storage media 1014 and executed on processors 1010. The device applications 1018 may include a device manager, such as any form of a control application, software application, signal-processing and control module, code that is native to a particular device, a hardware abstraction layer for a particular device, and so on.

The device applications 1018 also include any system components or modules to implement the techniques, such as learning module 122, learning subsets 128, characteristics 124, and/or specifications 126.

### CONCLUSION

Although embodiments of techniques and apparatuses enabling a tailored operating system learning experience have been described in language specific to features and/or methods, it is to be understood that the subject of the appended claims is not necessarily limited to the specific features or methods described. Rather, the specific features and methods are disclosed as example implementations enabling a tailored operating system learning experience.

What is claimed is:

1. A computer-implemented method comprising:
receiving a characteristic of a computing device, the computing device associated with an operating system (OS), the characteristic affecting use of an OS gesture;
receiving a specification of an OS environment affecting an appearance or operation of the OS gesture;
tailoring an OS learning experience demonstrating the OS gesture to the characteristic and the specification; and
presenting the tailored OS learning experience effective to demonstrate the use of the OS gesture according to the characteristic of the computing device and with the appearance or operation of the specification.

2. A computer-implemented method as described in claim 1, wherein the characteristic of the computing device is a hardware characteristic, the hardware characteristic including a touch-sensitive display or a physical keyboard, and tailoring the OS learning experience tailors the OS learning experience effective to demonstrate the OS gesture entered through the touch-sensitive display or the physical keyboard, respectively.

3. A computer-implemented method as described in claim 1, wherein the specification of the OS environment affects the appearance of the OS gesture, the specification including a color or a pointer type or size, and tailoring the OS learning experience tailors a pointer associated with the gesture to the color, the pointer type, or the pointer size.

4. A computer-implemented method as described in claim 1, wherein the specification of the OS environment affects the operation of the OS gesture, the specification including a left-to-right orientation or a right-to-left orientation, and tailoring the OS learning experience tailors the OS gesture to the left-to-right orientation or the right-to-left orientation, respectively.

5. A computer-implemented method as described in claim 1, wherein the OS gesture is a sizing gesture for an immersive environment enabled by the OS, an edge gesture, or a corner gesture.

6. A computer-implemented method as described in claim 1, wherein the tailored OS learning experience enables interactions to alter, in real time, the presentation of the OS learning experience.

7. One or more computer-readable storage media comprising computer-readable instructions that, when executed by one or more processors, perform operations comprising:
determining, based on a characteristic of a computing device, one or more subsets associated with the characteristic from operating system (OS) learning-experience subsets associated with a feature;
customizing the determined subsets based on a specification of an OS environment; and
creating an OS learning experience having the customized, determined subsets, the OS learning experience enabling demonstration of the feature according to the characteristic and the specification.

8. A computer-readable storage media according to claim 7, wherein the instructions, when executed, create the OS learning experience enabling interaction with the feature during presentation of the OS learning experience.

9. A computer-readable storage media according to claim 8, wherein the interaction is performed in conjunction with an operating system.

10. A computer-readable storage media according to claim 7, wherein the characteristic is a touch-sensitive display of the computing device and one of the customized, determined subsets is associated with a gesture feature and enables demonstration of a gesture through use of the touch-sensitive display.

11. A computer-readable storage media according to claim 7, wherein the specification includes a color, font size, font type, or pointer characteristic, and customizing customizes the determined subset to the specification by altering the determined subset to show the color, the font size, the font type, or the pointer characteristic.

12. A computer-implemented method comprising:
retrieving characteristics of a computing device, the computing device associated with an operating system (OS);
responsive to an initial login event, presenting an OS setup experience, the OS setup experience enabling selection of specifications to customize an OS environment for the OS;
receiving selected specifications customizing the OS environment;
creating an OS learning experience tailored to the characteristics of the computing device and the selected specifications; and
presenting the tailored OS learning experience.

13. A computer-implemented method as described in claim 12, wherein the tailored OS learning experience includes abstractions, the abstractions reducing a complexity of an actual representation of the OS.

14. A computer-implemented method as described in claim 12, wherein the tailored OS learning experience enables interactions to alter, in real time, the presentation of the tailored OS learning experience.

15. A computer-implemented method as described in claim 12, further comprising creating the OS setup experience, the OS setup experience tailored to the characteristics of the computing device.

16. A computer-implemented method as described in claim 12, wherein the characteristic of the computing device is a hardware characteristic, the hardware characteristic including a touch-sensitive display or a physical keyboard, and creating the OS learning experience tailors the OS learning experience to the touch-sensitive display or the physical keyboard, respectively.

17. A computer-implemented method as described in claim 12, wherein the selected specifications include one or more of a color, font type, font size, or language and creating the OS learning experience tailors the OS learning experience to include text associated thereof with the color, font type, font size, or language, respectively.

18. A computer-implemented method as described in claim 12, wherein the initial login event is a first boot of the OS or an entity's first login to the computing device.

19. A computer-implemented method as described in claim 12, wherein the tailored OS learning experience demonstrates use of a gesture usable to interact with or manage the OS.

20. A computer-implemented method as described in claim 12, further comprising enabling interaction with the tailored OS learning experience and, responsive to the interaction, tailoring presentation of the tailored OS learning experience to the interaction.
